(19) United States
(12) Patent Application Publication
(10) Pub. No.: US 2007/0089149 A1
(43) Pub. Date: Apr. 19, 2007

(54) DMB system and method for broadcasting user report

(75) Inventors: Jeong-Min You, Suwon-si (KR); Sang-Hyeon Yoon, Seoul (KR)

Correspondence Address: THE FARRELL LAW FIRM, 333 EARLE OVINGTON BOULEVARD., SUITE 701, UNIONDALE, NY, 11553, US

(73) Assignee: SAMSUNG ELECTRONICS CO., LTD., Suwon-si (KR)

(21) Appl. No.: 11/582,690

(22) Filed: Oct. 17, 2006

(30) Foreign Application Priority Data
Oct. 18, 2005 (KR) 2005-98177

(51) Int. Cl. H04N 7/173; G06F 13/00; G06F 3/00; H04N 7/16; H04N 5/445

(52) U.S. Cl. 725/105; 725/62; 725/61; 725/87

(57) ABSTRACT

Disclosed are a system and a method for broadcasting a user report. In the system and the method, a user transmits a user message including a report and location information stored in a digital multimedia broadcast receiving terminal to a digital multimedia broadcasting station as incoming information extracted from digital multimedia broadcasting signals. The digital multimedia broadcasting station receives the user message and the location information, generates area information which includes both area specific information of an area based on the user message and the location information and area specific information of adjacent areas, and broadcasts the area information. The digital multimedia broadcast receiving terminal having received the area information provides the area information to a user when previously stored location information is included in the area specific information of the area information. Accordingly, the user of the digital multimedia broadcast receiving terminal can obtain information on the report through the area information.

### PRIORITY

This application claims priority under 35 U.S.C. §119 to an application entitled “DMB System And Method For Broadcasting User Report” filed in the Korean Intellectual Property Office on Oct. 18, 2005 and assigned Serial No. 2005-98177, the contents of which are incorporated herein by reference.

### BACKGROUND OF THE INVENTION

1. Field of the Invention

The present invention relates to Digital Multimedia Broadcasting (DMB), and more particularly to a system and a method for broadcasting a message received from a user during a digital multimedia broadcasting such as a traffic broadcasting.

2. Description of the Related Art

Typically, digital multimedia broadcasting substitutes for conventional analog broadcasting and provides users with services having high picture and sound quality. In addition, with the development of digital broadcasting technology and mobile communication technology, interest in a digital broadcasting service in which a user can watch digital broadcasting while moving has increased. Accordingly, the current wireless terminal is provided with a non-directional digital multimedia broadcast reception antenna and has a function capable of decoding and reproducing digital multimedia broadcasting signals received through the antenna, so that a user can watch the digital multimedia broadcasting while moving. Hereinafter, the wireless terminal capable of receiving and reproducing digital multimedia broadcasting signals as described above will be referred to as a digital multimedia broadcast receiving terminal.

Such digital multimedia broadcasting includes an information channel, etc., for professionally broadcasting traffic information, etc., in addition to general broadcast programs. The traffic information channel comprehensively provides traffic information of an entire area at a specific time, and is broadcasted at a preset time similarly to general broadcasting. Herein, in the case of such a traffic information channel, when an emergency has occurred, it is necessary to quickly realize the emergency and inform users of the occurrence of the emergency within an area in which the emergency has occurred. However, using conventional traffic information channels, it is possible to be made aware of information by receiving reports transmitted by users or police.

However, in this case, in order for a user to report information about the emergency or information about the current traffic state to a broadcasting station for broadcasting traffic information, the user must directly input the phone number of the broadcasting station and dial the broadcasting station. Further, in order for the broadcasting station to determine if the user's report is false, a predetermined amount of time is required (i.e., must pass). Moreover, even in the event of an actual emergency it takes time (which can be of critical importance in emergency situations) to report information on the emergency to other users.

Further, in the case of the traffic information channel, even when an emergency has occurred in a certain area, the traffic information channel broadcasts comprehensive traffic information or a quick announcement, which includes the emergency. Therefore, users located outside the area in which the emergency has occurred, unnecessarily receive and/or may watch traffic information on the area in which the user is not located.

### SUMMARY OF THE INVENTION

Accordingly, the present invention has been made to solve the above-mentioned problems occurring in the prior art, and it is an object of the present invention to provide a system and a method for providing digital multimedia broadcasting, in which a user can more easily report an emergency when the emergency has occurred.

It is another object of the present invention to provide a system and a method for providing digital multimedia broadcasting, in which a user can receive only traffic information on an area including the user.

According to an aspect of the present invention, there is provided a digital multimedia broadcasting system for transmitting broadcasting signals which include both broadcasting content of digital multimedia broadcasting and incoming information for bi-directional communication based on the broadcasting content, the system including digital multimedia broadcast receiving terminal for receiving and reproducing the broadcasting signals, and transmitting both a user message input by a user and current location information to a digital multimedia broadcasting station which broadcasts broadcasting content based on the incoming information; and the digital multimedia broadcasting station for transmitting the broadcasting signals, receiving the user message and the location information from the digital multimedia broadcast receiving terminal, generating area information including area specific information extracted from the user message and the location information, and inserting the area information into the broadcasting signals.

According to another aspect of the present invention, there is provided a method by which a digital multimedia broadcasting station broadcasts a user message, which is received from a digital multimedia broadcast receiving terminal, to digital multimedia broadcast receiving terminals located in an area according to location information received with the user message, the digital multimedia broadcasting station transmitting both broadcasting content of digital multimedia broadcasting and broadcasting signals including incoming information of the broadcasting content, the method including selecting by the digital multimedia broadcasting station the received the user message; extracting by the digital multimedia broadcasting station at least area specific information based on the location information when the user message and the location information are received; generating by the digital multimedia broadcasting station area information including the extracted area specific information and the user message; and generating and transmitting by the digital multimedia broadcasting station broadcasting signals included in broadcasting content corresponding to the incoming information, the broadcasting content containing the generated area information.

According to a further aspect of the present invention, there is provided a method by which a user report digital multimedia broadcast receiving terminal transmits a user message input by a user to a digital multimedia broadcasting station in order to broadcast the user message to other digital multimedia broadcast receiving terminals located in an area according to location information of the user report digital multimedia broadcast receiving terminal, the digital multimedia broadcast receiving terminal receiving both broadcasting content of digital multimedia broadcasting and broadcasting signals including incoming information of the broadcasting content, the method including extracting, by the user report digital multimedia broadcast receiving terminal, the incoming information from the broadcasting signals; receiving, by the user report digital multimedia broadcast receiving terminal, base station specific information of a base station in an area in which the digital multimedia broadcast receiving terminal is currently located; and transmitting, by the user report digital multimedia broadcast receiving terminal, the received base station specific information and the user message to the digital multimedia broadcasting station.

According to still another aspect of the present invention, there is provided a method by which a digital-multimedia-broadcast receiving terminal receives broadcasting signals including area information with a message from a digital multimedia broadcasting station, the message being provided by a user report digital multimedia broadcast receiving terminal (URBT), the method including extracting, by the digital multimedia broadcast receiving terminal, the area information from the broadcasting signals; comparing, by the digital multimedia broadcast receiving terminal, area specific information included in the area information with current location information, and checking if area specific information matching the location information exists in the area specific information; and outputting, by the digital multimedia broadcast receiving terminal, the message included in the area information according to results of the checking.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a digital multimedia broadcasting system according to of the present invention;

FIG. 2 is a block diagram illustrating the construction of a broadcasting station according to the present invention;

FIG. 3 is a block diagram illustrating the construction of a digital multimedia broadcast receiving terminal according to the present invention;

FIG. 4 is a flow diagram illustrating a process in which a digital multimedia broadcast receiving terminal transmits a user message to a broadcasting station according to the present invention;

FIG. 5 is a flow diagram illustrating a process in which a digital multimedia broadcasting station transmits a user message received from a digital multimedia broadcast receiving terminal to a corresponding area according to the present invention;

FIG. 6 is a flow diagram illustrating a process in which a digital multimedia broadcasting station selects a predetermined number of user messages from received user messages according to the present invention;

FIG. 7 is a flow diagram illustrating a process in which a digital multimedia broadcast receiving terminal provides area information received from a digital multimedia broadcasting station according to the present invention; and

FIG. 8 is a diagram illustrating display screens of digital multimedia broadcast receiving terminal which are used for providing received area information to a user according to the present invention.

### DETAILED DESCRIPTION OF THE PREFERRED EMBODIMENT

Hereinafter, the present invention will be described with reference to the accompanying drawings. It should be noted that the similar components are designated by similar reference numerals although they may be illustrated in different drawings. Also, in the following description, a detailed description of known functions and configurations incorporated herein will be omitted when it may obscure the subject matter of the present invention.

First, a basic description of the present invention will be provided in order to better enable the reader to comprehend the present invention. Thus, according to the present invention, when an emergency occurs, a user can transmit both a message (user message), which includes a report regarding the emergency, and location information, which is included in a digital multimedia broadcast receiving terminal (terminal), to a digital multimedia broadcasting station (broadcasting station) as incoming information extracted from digital multimedia broadcasting signals. Then, the broadcasting station receives the user message and the location information, checks an area including the user, and stores the user message as a report regarding the emergency of the area.

Typically, emergencies can include accidents, traffic, travel, or road conditions (e.g., congestion, delays, road closures, travel restrictions, etc.), natural or weather-related emergencies (i.e., storms, earthquakes, etc.) and other conditions which require immediate attention (e.g., building evacuations, etc.).

Further, the broadcasting station generates both area specific information of the area based on the stored user message and the location information and area specific information of an adjacent area as area information of a corresponding area, and transmits broadcasting signals including the generated area information to the terminal. After receiving the area information, the terminal extracts the corresponding area information from the received broadcasting signals. When location information corresponding to that currently stored in the terminal exists in the area specific information included in the area information, the terminal provides the area information to the user according to the user's selection.

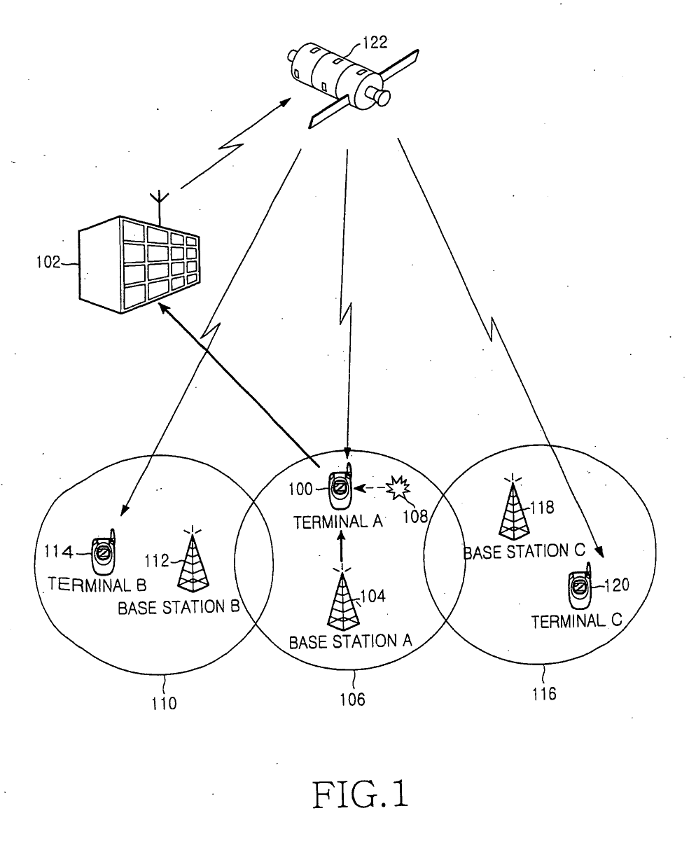

FIG. 1 is a block diagram illustrating the construction of a digital multimedia broadcasting system according to the present invention.

Referring to FIG. 1, when an emergency 108 has occurred, a terminal 100, which receives digital multimedia broadcasting signals from a broadcasting station 102, creates a message in order to report information about the emergency. After creating the message, the terminal 100 transmits area specific information of an area 106, which has been received from a base station 104 of the currently stored area 106, to the broadcasting station 102 as location information, together with the message. The message may also include images selected by a user. The location information may include base station identification (ID) of the base station 104.

The terminal 100 according to the present invention can use incoming information included in broadcasting signals received from one or more digital multimedia broadcasting satellites 122 in order to transmit the location information and the user message.

The incoming information represents information used in order to perform bi-directional communication between a content provider of digital multimedia broadcasting content and a user during digital multimedia broadcasting. The broadcasting content represent broadcasting programs, etc. broadcasted from the broadcasting station 102.

Generally, digital multimedia broadcasting provides a service in which a viewer can directly purchase favorite products while watching the digital multimedia broadcasting through a home shopping channel, etc., or request product information. Further, the incoming information is provided for the service.

The broadcasting station 102 inserts incoming information according to the current transmitted broadcasting content into broadcasting signals, and transmits the broadcasting signals. Generally, such incoming information is loaded on a Service Description Table (SDT) of an Electronic Program Guide (EPG) or a Telephone_descriptor of an Event Information Table (EIT), and then is broadcasted. The Telephone_descriptor of the EIT is defined in an European Telecommunications Standards Institute (ETSI). Table 1 below illustrates an example of the Telephone_descriptor of the EIT defined in the EN 300 468 of the ETSI.

TABLE 1

| | | Number | |
|---|---|---|---|
| Construction | | of bits | Limitation |
| Telephone Descriptor( ) { | | | |
| descriptor_tag | | 8 | ‘0 × 57’ |
| descriptor_length | | 8 | |
| reserved_future_use | | 2 | |
| foreign_availability | | 1 | |
| connection_type | | 5 | |
| reserved_future_use | | 1 | |
| country_prefix_length | | 2 | |
| international_area_code_length | | 3 | |
| operater_code_length | | 2 | |
| reserved_future_use | | 1 | |
| national_area_code_length | | 3 | |
| core_number_length | | 4 | |
| for(i=0;i<N;i++){ | | | |
| | country_prefix_char | 8 | |
| } | | | |
| for(i=0;i<N;i++){ | | | |
| | international_area_code _char | 8 | |

| | |
|---|---|
| } | |
| for(i=0;i<N;i++){ | |
| operater_code_char | 8 |
| } | |
| for(i=0;i<N;i++){ | |
| national_area_code_char | 8 |
| } | |
| for(i=0;i<N;i++){ | |
| core_number_char | 8 |
| }} | |

In Table 1, in order to represent incoming information, items such as a country_prefix_char, an international_area_code_char, an operator_code_char, a national_area_code_char, and a core_number_char are used. The country_{—prefix}_char includes an object of the incoming information (i.e., information on the name of a country in which the content provider is located). The international_area_code_char includes an international number for the name of the country only when the foreign_availability has a value of 1 from among the items in Table 1. The operator_code_char and the national_area_code_char are exclusively used. In other words, a telephone descriptor can include a number service provider identification and an area number of terminal 100. When the content provider uses a mobile communication terminal, the operator_code_char includes the number of a provider of a service which the content provider has joined (i.e., information such as 011). When the content provider uses a wired telephone, etc., instead of a mobile communication terminal, the national_area_code_char includes an area code of the wired telephone, etc. The core_number_char includes an international number and the area code, or specific information of the content provider excluding a service provider, etc. Table 2 below illustrates an example in which such items are expressed.

TABLE 2

country_prefix_char = “KOR”

international_area_code_char = 082

national_area_code_char = 032
core_number_char = 2233932

If the Telephone_descriptor of the EIT as shown in Table 1 is received, the (e.g., digital multimedia broadcast receiving terminal extracts incoming information “082-032-223-3932”) from the items and stores the extracted incoming information as incoming information.

When broadcasting content of the broadcasting station 102 corresponds to a traffic broadcasting program, the content provider of the broadcasting content corresponds to the broadcasting station 102 which provides the traffic broadcasting program. The following description will be given with the assumption that the content provider corresponds to the broadcasting station 102 in FIG. 1.

If the report regarding the emergency 108 (i.e., the user message received from the terminal 100 and the location information of the terminal 100), is received, the content provider (i.e., the broadcasting station 102) according to the embodiment of the present invention, recognizes the area 106 in which the terminal 100 is located. Then, the broadcasting station 102 loads the area specific information of the area 106 in which the terminal 100 is located, the specific information of a base station 112 in an area 110 adjacent to the area 106, and the area specific information of a base station 118 in an area 116. Further, the broadcasting station 102 generates area information including the loaded area specific information and the received user message, and transmits the current provided broadcasting signals including the generated area information. Accordingly, in the digital multimedia broadcasting system according to the present invention, the broadcasting signals provided from the broadcasting station 102 include the user message reported from the user and the area specific information. When multiple user messages are received from the broadcasting station 102, it is also possible to extract a predetermined number of user messages from the received user messages through preset criteria (which will be described below).

After a terminal 114 and a terminal 120 receive the broadcasting signals including the area information from the digital multimedia broadcasting satellite 122, each of the terminals 114 and 120 parses the received broadcasting signals. When the broadcasting signals include the area information, each of the terminals 114 and 120 compares the current stored location information with the area specific information included in the area information. Further, when mutually matched area specific information exists in the area specific information included in the area information, each of the terminals 114 and 120 informs users of reception of the area information. If a user selects transmission of the area information, each of the terminals 114 and 120 provides the user with the area information.

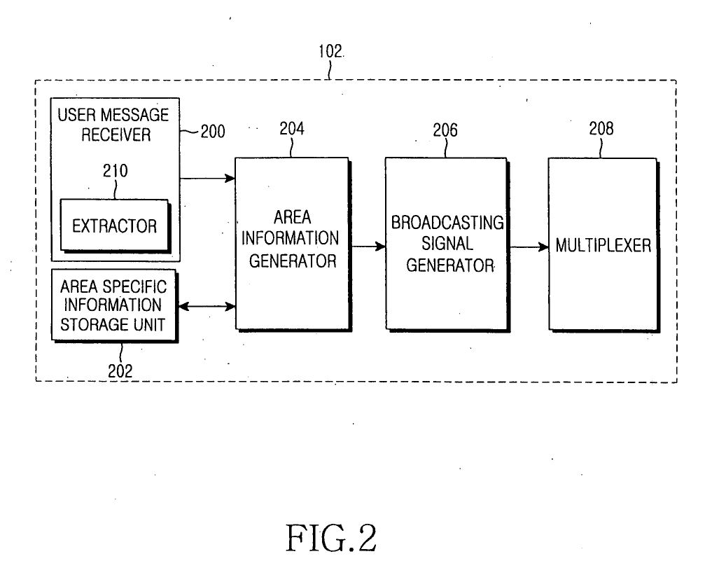

FIG. 2 is a block diagram illustrating the construction of the broadcasting station 102 according to the present invention.

Referring to FIG. 2, the broadcasting station 102 can include a user message receiver 200, an area specific information storage unit 202, an area information generator 204, a broadcasting signal generator 206, and a multiplexer 208.

When the emergency has occurred, the user message receiver 200 receives both the user messages and the location information for reporting the occurred emergency. Then, the user message receiver 200 outputs the received user messages and location information to the area information generator 204. Herein, the user message receiver 200 may also classify the user messages according to the received location information. When multiple user messages are received, it is also possible to extract some of the user messages from the received user messages through preset criteria. For example, the preset criteria may include information indicating whether the user message includes an image, a reception time of the user message, etc.

In such a case, the user message receiver 200 may either extract only user messages including images from the received user messages by means of an extractor 210 which can be included therein, or may classify the received user messages based on reception time and extract a predetermined number of user messages in a sequence of the reception time.

If the user message and the location information are received by the user message receiver 200, the area information generator 204 extracts both area specific information according to the location information and area specific information on an area adjacent to the area according to the location information. This will be described with reference to FIG. 1. If the area specific information according to the location information was the specific information of the base station 104, the area information generator 204 extracts the specific information of the base stations 112 and 118 within adjacent areas, as well as the specific information of the base station 104. Then, the area information generator 204 generates area information including the extracted area specific information and the user message.

The area information generator 204 outputs the generated area information to the broadcasting signal generator 206. The broadcasting signal generator 206 according to the present invention inserts the area information input from the area information generator 204 into broadcasting signals of the currently provided broadcasting contents, and broadcasts the area information. Further, the broadcasting signal generator 206 outputs the broadcasting signals to the multiplexer 208.

The multiplexer 208 multiplexes the broadcasting signals including the area information, and transmits the multiplexed broadcasting signals to the digital multimedia broadcasting satellite 122. The broadcasting signals including the area information are broadcasted to the terminals 100, 114, and 120 through the digital multimedia broadcasting satellite 122.

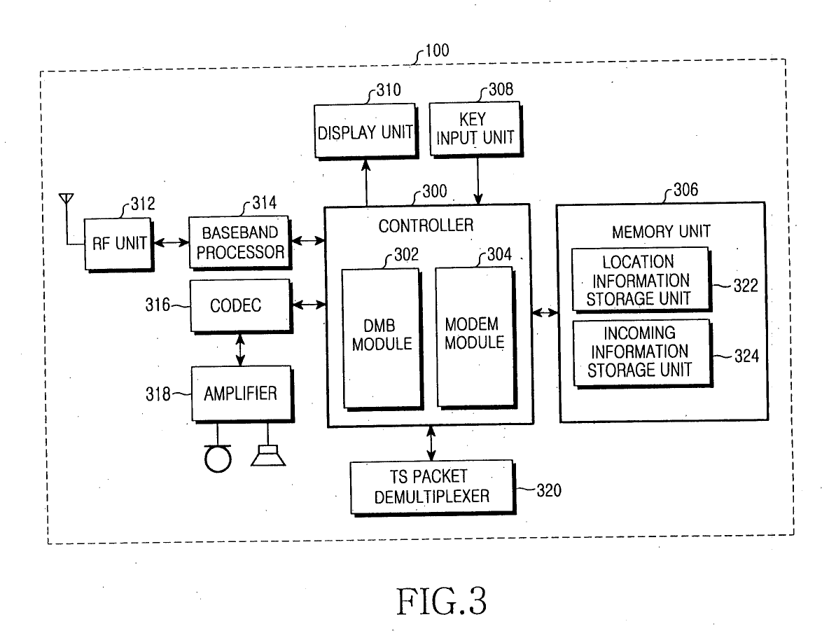

FIG. 3 is a block diagram illustrating the construction of the digital multimedia broadcast receiving terminal according to the present invention. The digital multimedia broadcast receiving terminal according to the embodiment of the present invention can include terminals 100, 114, and 120 as shown in FIG. 1. The terminal 100 can include a memory unit 306, a key input unit 308, a display unit 310, a baseband processor 314, a CODER-DECODER (CODEC) 316, and a Transport Stream (TS) packet demultiplexer 320 are connected to a controller 300. The controller 300 controls the overall operation of the terminal 100. Further, the controller 300 receives key input of a user from the key input unit 308, and controls the display unit 310 so that image information based on the key input of the user can be generated and provided.

The controller 300 includes a modem module 304 and a DMB module 302. The modem module 304 processes voice signals and data according to protocols for phone communication, data communication, and wireless Internet access. Further, the modem module 304 receives specific information of a base station from the base station in an area including the terminal 100, and stores the received specific information in the memory unit 306 as location information. According to the present invention, the modem module 304 transmits both messages created by a user and the location information to the broadcasting station 102.

The DMB module 302 receives digital multimedia broadcasting signals including image data, audio data, and information data from the broadcasting station 102, decodes the digital multimedia broadcasting signals by using a DMB image decoder for decoding of the image data and a DMB audio decoder for decoding of the audio data, and controls the output of the decoded digital multimedia broadcasting signals. Further, the DMB module 302 receives broadcasting signals according to channels selected by a user, and reproduces and outputs digital multimedia broadcasting contents corresponding thereto. Further, the DMB module 302 extracts incoming information from the broadcasting contents. When the broadcasting signals include the area information according to the present invention, the DMB module 302 compares area specific information included in the area information with the location information stored in the memory unit 306. When the location information is included in the area specific information, the DMB module 302 informs a user of the existence of the area information. Herein, when the user selects output of the area information, the DMB module 302 outputs messages or images included in the area information to the display unit 310. As used herein, the location information includes information of the broadcasting station in which the terminal is located, and the area information includes the user's message and the area specific information. Additionally, the area specific information includes specific information of an area and adjacent areas corresponding to a terminal which transmitted the user message because the user message should provide a notification of a user in the corresponding and adjacent areas. If location information is included in the area specific information, the terminal recognizes that the area information broadcast from the broadcasting station corresponds to information of user's location, and informs the user of it.

The memory unit 306 coupled to the controller 300 stores the location information currently stored through the modem module 304. Further, the memory unit 306 stores the incoming information included in the broadcasting contents provided when the digital multimedia broadcasting signals are received. Hereinafter, an area of the memory unit 306 for storing the location information will be referred to as a location information storage unit 322, and an area of the memory unit 306 for storing the incoming information will be referred to as an incoming information storage unit 324.

Such a memory unit 306 may include a Read Only Memory (ROM), a flash memory, a Random Access Memory (RAM), etc. The ROM stores programs and various reference data for processing and control of the controller 300. The RAM provides a working memory of the controller 300, and the flash memory provides an area for storing various renewable storage data:

The key input unit 308 includes various keys (e.g., function keys, letter keys, etc.) in addition to number keys (e.g., numeric keys), and provides key input from a user to the controller 300. A Radio Frequency (RF) unit 312 transmits and/or receives RF signals to and/or from a base station. Further, the RF unit 312 converts the received signals into Intermediate Frequency (IF) signals, and outputs the IF signals to the baseband processor 314 connected to the controller 300. Further, the RF unit 312 converts IF signals input from the baseband processor 314 into RF signals, and transmits the RF signals. Herein, the RF unit 312 has a construction for receiving digital multimedia broadcasting signals. The baseband processor 314 corresponds to a Baseband Analog ASIC (Application Specific Integrated Circuit) (BBA) for providing an interface between the controller 300 and the RF unit 312. Further, the baseband processor 314 converts baseband digital signals applied from the controller 300 into analog IF signals, and applies the analog IF signals to the RF unit 312. Further, the baseband processor 314 converts analog IF signals applied from the RF unit 312 into baseband digital signals, and applies the baseband digital signals to the controller 300.

When the broadcasting signals are received through the RF unit 312, the TS packet demultiplexer 320 demultiplexes the TS packets of the broadcasting signals. The TS packet demultiplexer 320 includes a TS packet receiver for buffering the TS packets input from the RF unit 312, a demultiplexer for demultiplexing the received TS packets, a Program Specific Information (PSI) parsing unit for parsing PSI, such as a Service Description (SDT), a Program Association Table (PAT), a Program Map Table (PMT), a Conditional Access Table (CAT), an Event Information Table (EIT), etc. The TS packet demultiplexer 320 demultiplexes the TS packets received from the RF unit 312, parses the PSI from the demultiplexed TS packets so as to extract incoming information from the corresponding broadcasting signals, and checks if the area information is included in the broadcasting signals. Then, the TS packet demultiplexer 320 informs the controller 300 of the results of the check.

The CODEC 316 coupled to the controller 300 is connected to a microphone and a speaker through an amplifier 318. Voice signals input from the microphone can be encoded by the CODEC 316 using a Pulse Code Modulation (PCM) technique. The CODEC 316 can output voice data to the controller 300. Further, the CODEC 316 PCM-decodes voice data input from the controller 300, and outputs the decoded voice data to the speaker through the amplifier 318. The amplifier 318 amplifies the voice signals input from the microphone or the voice signals output to the speaker. Herein, the amplifier 318 adjusts the volume of the speaker and the gain of the microphone under the control of the controller 300. When the audible signals of digital multimedia broadcasting signals are received from the controller 300, the amplifier 318 amplifies the audible signals and outputs the amplified audible signals through the speaker.

The system according to the present invention can be restrictively used when a user is watching specific broadcasting contents. For example, if it is assumed that a user watching traffic broadcasting through a traffic information channel reports conditions such as current traffic congestion of an area including the user to the broadcasting station 102, the broadcasting station 102 can provide the user's report only to viewers watching the same traffic broadcasting program through the traffic channel. In the following description, it is assumed that all of the terminals 100, 114 and 120 in FIG. 1 receive the same broadcasting contents in consideration of such a case.

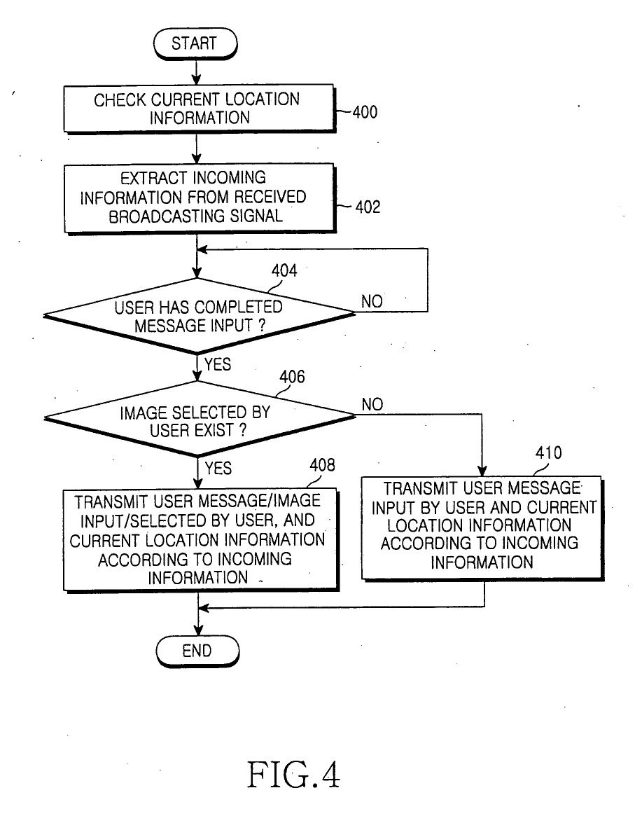

FIG. 4 is a flow diagram illustrating a process in which the terminal 100 receiving specific broadcasting contents such as traffic broadcasting transmits a user message to the broadcasting station 102 according to the present invention.

Referring to FIG. 4, when the emergency 108 has occurred, if a user selects a function for reporting the emergency 108, the controller 300 checks the location information stored in the location information storage unit 322 in step 400. In step 402, the controller 300 extracts incoming information from the received broadcasting signals. Herein, the controller 300 may extract the incoming information from the items used for representing the incoming information as shown in Tables 1 and 2 above.

When the incoming information is extracted, the controller 300 checks if the user has completed message input in step 404. If the user has completed the message input, the controller 300 checks if there exist one or more images selected by the user in step 406. Herein, the images selected by the user may include images stored by means of a camera installed at the digital multimedia broadcast receiving terminal according to the embodiment of the present invention. If images selected by the user exist in step 406, the controller 300 transmits both the user message input by the user and the images selected by the user to the broadcasting station 102 providing the broadcasting contents according to the extracted incoming information, together with the checked location information in step 408. In this way, the user can store the occurred emergency 108 as images and transmit the images together with the user message, as well as simple messages. Accordingly, in the embodiment of the present invention, it is possible to transfer information corresponding to the emergency 108.

However, in step 406, if it is determined no images were selected by the user, the controller 300 transmits both the user message input by the user and the checked location information to the broadcasting station 102 according to the extracted incoming information in step 410.

Herein, the user message sent from the digital multimedia broadcast receiving terminal includes caller information such as a phone number of a user, and is substantially identically to a general Short Message Service (SMS) message or Multimedia Message Service (MMS) message. When a user has optionally preset a nickname desired by the user, the digital multimedia broadcast receiving terminal according to the present invention may also transmit the caller information including the nickname. In such a case, if the broadcasting station 102 transmits broadcasting signals including the user message, the nickname preset by the user is expressed (e.g., displayed), instead of (or with) the caller information of the user.

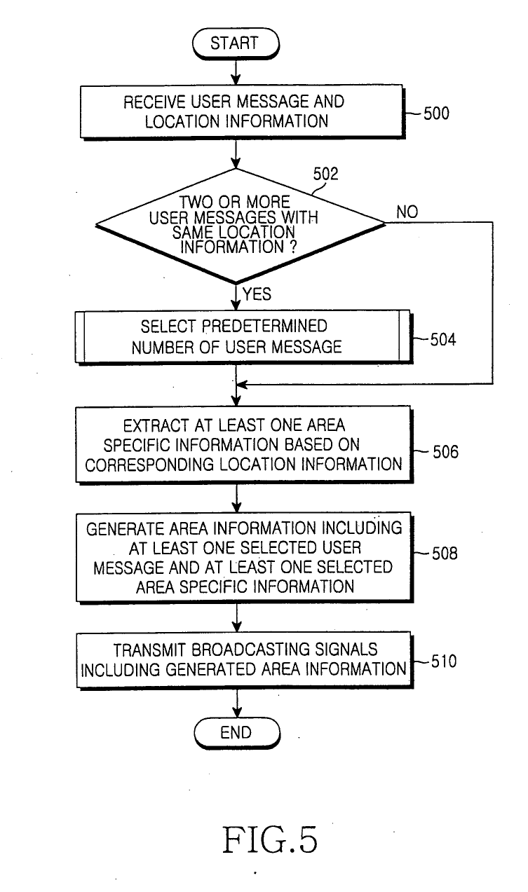

FIG. 5 is a flow diagram illustrating a process in which the digital multimedia broadcasting station transmits the user message received from the digital multimedia broadcast receiving terminal to a corresponding area according to the present invention.

Referring to FIG. 5, in step 500, the broadcasting station 102, which transmits digital multimedia broadcasting signals receives the user message and location information, which has been transmitted from a digital multimedia broadcast receiving terminal (e.g., 100, 114, and/or 118). In step 502, the broadcasting station 102 checks if two or more user messages with the same location information have been received during a predetermined time. As a result of the check, if only one user message with the same location information has been received during the predetermined time, the broadcasting station 102 checks the location information according to the received user message, and extracts area specific information of an area, which is adjacent to an area based on the location information, from the area specific information storage unit 202, in step 506. For example, the area specific information may include base station identification (Ids) of each cell in a cellular mobile communication system.

However, if two or more user messages with the same location information have been received during the predetermined time, the broadcasting station 102 selects only a predetermined number of user messages from the received user messages according to preset criteria in step 504.

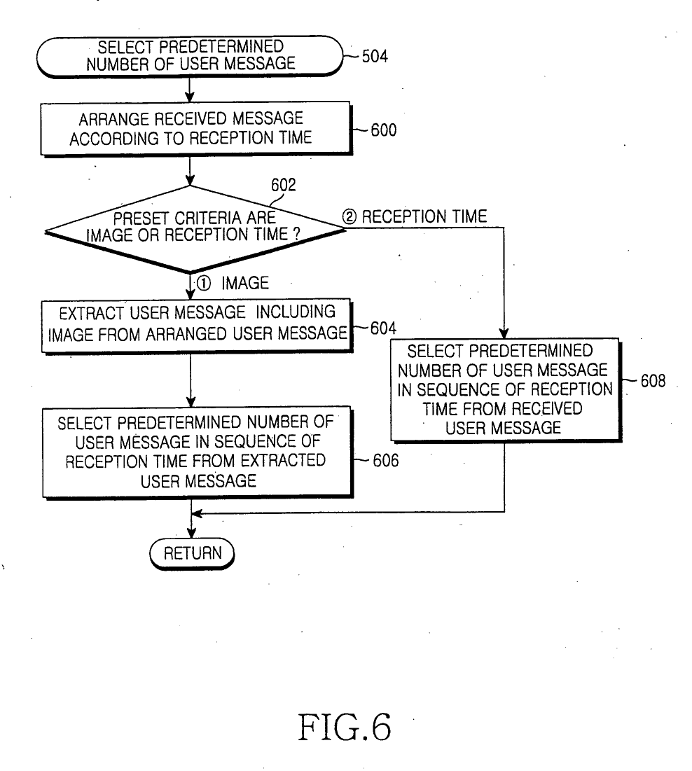

Herein, various preset criteria may be provided. For example, in order to select more exact information from the received user messages, the broadcasting station 102 may also preferentially select only user messages with images from the user messages. Further, in order to transfer information more quickly, the broadcasting station 102 may also preferentially select user messages having an earlier reception time from among the user messages. A process by which the broadcasting station 102 selects the predetermined number of user messages from the user messages according to the preset criteria will be described in detail with reference to FIG. 6.

In step 506, the broadcasting station 102 checks the location information according to the received user message, and extracts area specific information of an area, which is adjacent to an area based on the location information, from the area specific information storage unit 202. That is, referring to FIG. 1, the broadcasting station 102 extracts specific information of the base stations 112 and 118 within the areas 110 and 116 adjacent to the area 106 based on the location information of the terminal 100.

In step 508, the broadcasting station 102 generates area information including at least one user message and at least one area specific information, which are selected and extracted through steps 502, 504 and 506. Herein, when a user message including nickname information exists in said at least one selected user message, the broadcasting station 102 generates the area information by means of the nickname information instead of caller information of the user messages. In step 510, the broadcasting station 102 inserts the generated area information into broadcasting signals of broadcasting contents based on incoming information of the user message, and transmits the broadcasting signals. If the broadcasting content based on the incoming information corresponds to traffic broadcasting, the broadcasting station 102 inserts the area information into broadcasting signals of the traffic broadcasting, and transmits the broadcasting signals. In this way, the area information is transmitted to other terminals receiving the same broadcasting content when the terminal transmits the user message.

FIG. 6 is a flow diagram illustrating a process in which the digital multimedia broadcasting station selects the predetermined number of user messages from the received user messages according to the present invention.

Referring to FIG. 6, if two or more user messages with the same location information have been received during the predetermined time in step 502 of FIG. 5, the broadcasting station 102 arranges the received user messages according to reception times in step 600. In step 602, the broadcasting station 102 checks preset criteria. Hereinafter, whether the user message includes images and reception times as described above will be described as an example of the preset criteria. Herein, the preset criteria may be altered according to selection of a content provider.

As a result of checking the preset criteria in step 602, if the preset criteria correspond to whether the user message includes images, the broadcasting station 102 extracts user messages including the images from the arranged user messages in step 604. In step 606, the broadcasting station 102 optionally selects a predetermined number of user messages in a sequence of reception time from the extracted user messages.

However, if the preset criteria correspond to the reception time, the broadcasting station 102 can select a predetermined number of user messages in sequence of reception time from the currently received user messages in step 608. If at least one user message is selected through step 606 or 608, the process returns to step 506. That is, the broadcasting station 102 checks the location information according to the selected user messages, and extracts the area specific information of the area adjacent to the area based on the location information, in step 506.

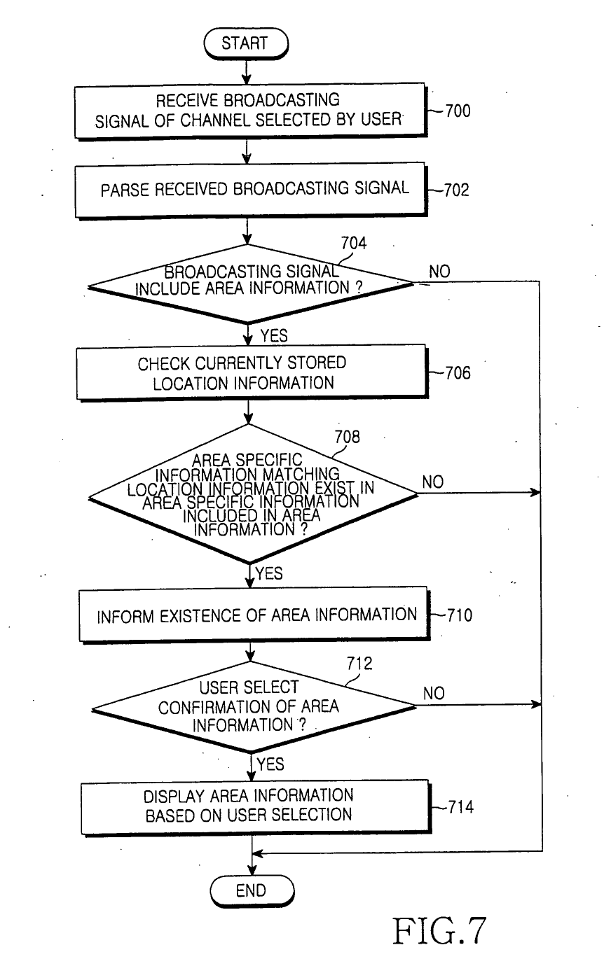

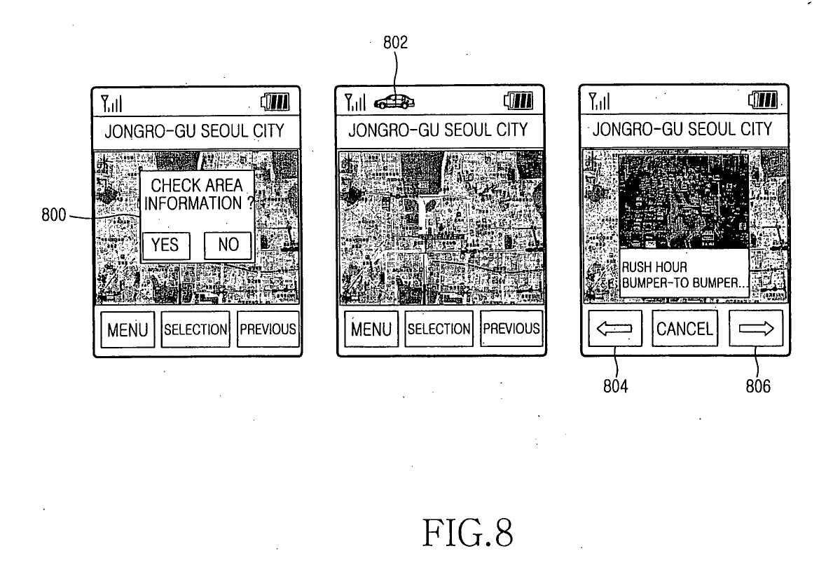

FIG. 7 is a flow diagram illustrating a process in which the digital multimedia broadcast receiving terminal provides the area information received from the digital multimedia broadcasting station according to the present invention, and FIG. 8 is a diagram illustrating display screens of digital multimedia broadcast receiving terminal providing the received area information to a user according to the present invention. Hereinafter, a process for providing the area information to the user when the area information is received will be described with reference to FIGS. 7 and 8.

Referring to FIG. 7, in step 700, the controller 300 of the digital multimedia broadcast receiving terminal according to the present invention receives broadcasting signals based on broadcasting content of a channel selected by the user. In step 702, the controller 300 parses the received broadcasting signals in order to reproduce and output the received broadcasting signals. In step 704, the controller 300 checks if the received broadcasting signals include area information.

As a result of the check in step 704, if the received broadcasting signals include the area information, the controller 300 checks the location information stored in the location information storage unit 322 of the memory unit 306 in step 706. In step 708, the controller 300 compares area specific information included in the area information with the location information, thereby checking if area specific information matching the location information exists in the area specific information.

As a result of the check in step 708, if area specific information matching the location information, the controller 300 informs a user of the existence of the area information in step 710. Herein, there may exist various methods for informing the user of the existence of the area information. For example, it may be possible to inform the user of the reception of the area information through a pop-up window, an icon, etc.

Referring to FIG. 8, screen (a) is a screen shot illustrating a display screen for informing the user of the reception of the area information through a pop-up window 800, and screen (b) is a screen shot illustrating a display screen for informing the user of the reception of the area information through an icon 802. Herein, the pop-up window or the icon may be contributed to elevate the recognition of a user through a snooze scheme in which the pop-up window or the icon is repeatedly turned on/off. Moreover, an audible or vibratory message can also optionally be used to inform the user of the received area information.

In step 712, the controller 300 checks if the user has selected confirmation of the area information. If the user has selected the confirmation of the area information, the controller 300 displays the received area information in step 714.

As described above, the area information may include at least one user message. When two or more user messages are included in the area information, the user may selectively confirm the user messages. Such an example will be described with reference to screen shot (c) of FIG. 8. When two or more user messages are included in the area information, the user may select and confirm the user messages by using a previous selection key 804 or a next selection key 806. This is better illustrated with reference to the screen shot (c) shown in FIG. 8, in which keys such as 804 (i.e., a previous selection key) and 806 (i.e., a next selection key) 806 can be used to search user messages included in desired area information. For example, it may also be possible to optionally set and use keys such as left and right arrow keys, a # key and a * key. In this way, the user of the digital multimedia broadcast receiving terminal having received such area information can obtain more exact information through the area information including a plurality of user messages.

According to the present invention as described above, when an emergency has occurred, a user can more easily report the emergency, and a user receiving the information can receive only traffic information corresponding to an area in which the user is located. Consequently, the user of a digital multimedia broadcast receiving terminal having received such area information can more exactly and quickly obtain the information on the user' report through the area information.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof. Specifically, the present invention provides a case in which terminals 100, 114, and 120 can receive traffic broadcasting, with terminal 100 transmitting user messages to the broadcasting station 102, and terminals 114 and 120 receiving area information including the user messages from the broadcasting station 102. However, the present invention is not limited to broadcasting contents such as traffic broadcasting. For example, in the case of broadcasting contents for professionally providing a specific field such as sports broadcasting, the broadcasting contents may also be used when a plurality of users watching the corresponding broadcasting contents share information.

What is claimed is:

1. A digital multimedia broadcasting system for transmitting broadcasting signals which include both broadcasting content of digital multimedia broadcasting and incoming information for bi-directional communication based on the broadcasting content, the system comprising:
a user-report digital multimedia broadcast receiving terminal for receiving and reproducing the broadcasting signals, and transmitting a user message input by a user and current location information to a digital multimedia broadcasting station which broadcasts broadcasting content based on the incoming information; and
the digital multimedia broadcasting station for transmitting the broadcasting signals, receiving the user message and the location information from the user-report digital multimedia broadcast receiving terminal, generating area information including area specific information extracted from the user message and the location information, and inserting the area information into the broadcasting signals of the broadcasting content.

2. The system as claimed in claim 1, wherein the location information corresponds to base station specific information of an area in which the user-report digital multimedia broadcast receiving terminal is located in, and the area specific information corresponds to base station specific information of an area in which the user-report digital multimedia broadcast receiving terminal is located in.

3. The system as claimed in claim 1, wherein the area specific information further includes information corresponding to base station specific information of areas adjacent to the area in which the user-report digital multi-media broadcast receiving terminal is located.

4. The system as claimed in claim 1, wherein the user report digital multimedia broadcast receiving terminal inserts data corresponding to images selected by the user into the user message, and transmits the user message to the digital multimedia broadcasting station.

5. The system as claimed in claim 2, wherein the user-report digital multimedia broadcast receiving terminal includes:
a location information storage unit for receiving base station specific information from a base station in an area, in which the user-report digital multimedia broadcast receiving terminal is currently located, as area specific information, and storing the area specific information as the location information;
a TS (transport stream) packet demultiplexer for parsing the broadcasting signals and extracting the incoming information;
an incoming information storage unit for storing the extracted incoming information; and
a controller for receiving the user message from the user, and transmitting the received user message to the digital multimedia broadcasting station according to the extracted incoming information stored in the incoming information storage unit, together with the location information stored in the location information storage unit.

6. The system as claimed in claim 2, further including at least one digital multimedia broadcast receiving terminal for transmitting a user message included in the area information when broadcasting signals including the area information are received from the digital multimedia broadcasting station and area specific information, which corresponds with location information currently stored in the digital multimedia broadcast receiving terminal, exists in at least one area specific information included in received area information.

7. The system as claimed in claim 2, wherein the digital multimedia broadcasting station includes:
a user message receiver for receiving the user message and the location information from the user-report digital multimedia broadcast receiving terminal, and selecting the received user message;
an area specific information storage unit for storing area specific information of each area in order to extract area specific information of an area adjacent to an area corresponding to the location information;
an area information generator for extracting area specific information based on the location information from the area specific information storage unit, and generating area information including both the user message selected by the user message receiver and the extracted area specific information; and
a broadcasting signal generator for generating broadcasting signals including the area information contained in the broadcasting content corresponding to the incoming information.

8. The system as claimed in claim 7, wherein the user message receiver further includes an extractor for extracting a predetermined number of user messages according to one or more criterion from at least two user messages received during a predetermined time period.

9. The system as claimed in claim 8, wherein the extractor preferentially extracts the predetermined number of user messages including images, from among the received user messages.

10. The system as claimed in claim 8, wherein the extractor selects and extracts the predetermined number of user messages sequentially according to reception time.

11. The system as claimed in claim 1, wherein the user report digital multimedia broadcast receiving terminal transmits the user message including identification information preset by a user.

12. The system as claimed in claim 11, wherein, when the identification information is contained in the user message included in the area information, the digital multimedia broadcasting station transmits the identification information as caller information of the user message.

13. A method by which a digital multimedia broadcasting station broadcasts a user message, which is received from a user-report digital multimedia broadcast receiving terminal, to digital multimedia broadcast receiving terminals located in an area according to location information received together with the user message, the digital multimedia broadcasting station transmitting both broadcasting content of digital multimedia broadcasting and broadcasting signals including incoming information of the broadcasting content, the method comprising:
selecting, by the digital multimedia broadcasting station, the received user message;
extracting, by the digital multimedia broadcasting station, at least one area specific information based on the location information when the user message and the location information are received;
generating, by the digital multimedia broadcasting station, area information including said at least one extracted area specific information and the user message; and
generating and transmitting by the digital multimedia broadcasting station broadcasting signals included in broadcasting content corresponding to the incoming information, the broadcasting content containing the generated area information.

14. The method as claimed in claim 13, wherein the step of selecting the received user message includes:
when at least two user messages are received, extracting, by the digital multimedia broadcasting station, a predetermined number of user messages according to preset criteria; and
selecting, by the digital multimedia broadcasting station, the at least one extracted user message.

15. The method as claimed in claim 14, wherein, the step of extracting the predetermined number of user messages includes extracting, by the digital multimedia broadcasting station, the predetermined number of user messages including images from among the received user messages.

16. The method as claimed in claim 14, wherein, in the step of extracting the predetermined number of user messages, includes extracting, by the digital multimedia broadcasting station, the predetermined number of user messages according to reception time.

17. The method as claimed in claim 13, wherein the location information corresponds to base station specific information of an area in which the user-report digital multimedia broadcast receiving terminal is located.

18. The method as claimed in claim 17, wherein the step of extracting the area specific information includes:
checking, by the digital multimedia broadcasting station, base station specific information of an area based on the location information; and
extracting, by the digital multimedia broadcasting station base station, specific information of areas adjacent to an area based on the base station specific information.

19. The method as claimed in claim 13, wherein the step of the area information includes:
checking, by the digital multimedia broadcasting station, if the user message includes user identification information preset by a user of the user-report digital multimedia broadcast receiving terminal;
when the user message includes the user identification information, including, by the digital multimedia broadcasting station, the user identification information in caller information of the user message; and
generating area information including the user message, in which the user identification information is written as caller information, and the at least one extracted area specific information.

20. A method by which a user-report digital multimedia broadcast receiving terminal transmits a user message input by a user to a digital multimedia broadcasting station in order to broadcast the user message to digital multimedia broadcast receiving terminals located in an area according to location information of the user report digital multimedia broadcast receiving terminal, the digital multimedia broadcast receiving terminal receiving both broadcasting content of digital multimedia broadcasting and broadcasting signals including incoming information of the broadcasting content, the method comprising:
extracting, by the user report digital multimedia broadcast receiving terminal, the incoming information from the broadcasting signals;
receiving, by the user report digital multimedia broadcast receiving terminal, base station specific information of a base station in an area in which the digital multimedia broadcast receiving terminal is currently located; and
transmitting, by the user report digital multimedia broadcast receiving terminal, the received base station specific information and the user message to the digital multimedia broadcasting station.

21. The method as claimed in claim 20, further comprising:
checking, by the user report digital multimedia broadcast receiving terminal, if user identification information preset by the user exists; and
when the user identification information is determined to exist, inserting, by the user report digital multimedia broadcast receiving terminal, the user identification information into the user message, and transmitting the user message.

22. A method by which a digital multimedia broadcast receiving terminal receives broadcasting signals including area information with a message received from a digital multimedia broadcasting station, and providing the area information, the message being provided by a user-report digital multimedia broadcast receiving terminal, the method comprising:
extracting, by the digital multimedia broadcast receiving terminal, the area information from the broadcasting signals;
comparing, by the digital multimedia broadcast receiving terminal, area specific information included in the area information with current location information, and determining whether area specific information corresponding to the location information exists in the area specific information; and
outputting, by the digital multimedia broadcast receiving terminal, the message included in the area information according to results of the determination.

23. The method as claimed in claim 22, wherein the location information corresponds to base station specific information of an area in which the digital multimedia broadcast receiving terminal is currently located.

24. The method as claimed in claim 23, wherein, in the step of determining, the digital multimedia broadcast receiving terminal checks if area specific information matching the location information exists in the area specific information.

25. The method as claimed in claim 22, wherein the step of outputting the message includes:
outputting, by the digital multimedia broadcast receiving terminal, the message included in the area information according to the results of the determination; and
when at least two messages are included in the area information, outputting, by the digital multimedia broadcast receiving terminal, a message according to selection of a user from among said at least two messages.

26. The method as claimed in claim 25, wherein, in the step of outputting the message, the digital multimedia broadcast receiving terminal searches for the message according to the selection of the user depending on whether a predetermined key for selecting one of the messages is input.
